(19) United States
(12) Patent Application Publication
(10) Pub. No.: US 2022/0351067 A1
(43) Pub. Date: Nov. 3, 2022

(54) PREDICTIVE PERFORMANCE ON SLICES VIA ACTIVE LEARNING

(71) Applicant: International Business Machines Corporation, Armonk, NY (US)

(72) Inventors: Michael DESMOND, White Plains, NY (US); Matthew Richard ARNOLD, Ridgefield Park, NJ (US); Jeffrey Scott BOSTON, Wappingers Falls, NY (US)

(21) Appl. No.: 17/244,649

(22) Filed: Apr. 29, 2021

(51) Int. Cl. G06N 20/00; G06N 7/00

(52) U.S. Cl. CPC G06N 20/00; G06N 7/005

(57) ABSTRACT

A method includes applying a machine learning model to a plurality of unlabeled datapoints to produce probability distributions for labels for the plurality of unlabeled datapoints, selecting a first subset of unlabeled datapoints from the plurality of unlabeled datapoints that satisfy a criterion, and selecting a second subset of unlabeled datapoints from the first subset based on the probability distributions for labels for the unlabeled datapoints in the first subset. The second subset is smaller than the first subset. The method also includes communicating, to a user, the second subset of unlabeled datapoints, receiving, from the user, labels for the second subset of unlabeled datapoints, and training, using the received labels, the machine learning model.

### BACKGROUND

The present invention relates to machine learning models, and more specifically, to improving the predictive performance of machine learning models. Machine learning models are trained to make predictions based on input data. The machine learning models are evaluated based on the accuracy of their predictions. Thus, it is important for a machine learning model to generate accurate predictions. One way to train machine learning models is to present the machine learning models with labeled data, which includes input data paired with labels that indicate the correct prediction based on that input data. The machine learning models may engage in active learning in which the machine learning models present to users the input data for which the machine learning models made predictions but the machine learning models are not confident that these predictions are accurate. The users then label this input data to teach the machine learning models what the correct predictions were. The machine learning models are trained using these labels so that the machine learning models make more accurate and confident predictions for this input data in the future.

Active learning generally aims to improve the overall performance of machine learning models. However, it is important for model designers to be able to improve a model's performance on certain segments or categories of input data, also referred to as “slices.” Active learning is not well suited for targeted improvement of machine learning models, particularly improving the performance of machine learning models on slices of data.

### SUMMARY

According to one embodiment, a method includes applying a machine learning model to a plurality of unlabeled datapoints to produce probability distributions for labels for the plurality of unlabeled datapoints, selecting a first subset of unlabeled datapoints from the plurality of unlabeled datapoints based on a criterion, and selecting a second subset of unlabeled datapoints from the first subset based on the probability distributions for labels for the unlabeled datapoints in the first subset. The second subset is smaller than the first subset. The method also includes communicating, to a user, the second subset of unlabeled datapoints, receiving, from the user, labels for the second subset of unlabeled datapoints, and training, using the received labels, the machine learning model. In this manner, the machine learning model's predictive performance for a slice of data is improved using active learning.

In some embodiments, the criterion specifies a first label and a second label. Each of the probability distributions for labels for the unlabeled datapoints in the second subset includes a highest probability and a second highest probability. The highest probability is for the first label and the second highest probability is for the second label. In this manner, the criterion defines a slice of data based on the initial predictions made for that data. Additionally, each unlabeled datapoint of the second subset may be selected based on a difference between the highest probability and the second highest probability of the probability distribution of the respective unlabeled datapoint being less than a threshold. In this manner, the slice of data is sampled to locate the data for which the machine learning model is least confident about its prediction.

In certain embodiments, each unlabeled datapoint of the second subset is selected based on an entropy of the probability distribution of the respective unlabeled datapoint exceeding a threshold. In this manner, the slice of data is sampled to locate the data for which the machine learning model is least confident about its prediction.

In particular embodiments, the method further includes, after training the machine learning model using the received labels, applying the machine learning model to the first subset of unlabeled datapoints to produce labels for the first subset of unlabeled datapoints. In this manner, the machine learning model generates more accurate predictions after training.

In some embodiments, the method also includes determining the criterion based on the probability distributions. In this manner, the machine learning model automatically determines the criterion to use to define a slice.

In certain embodiments, training the machine learning model includes adding the received labels and the second subset of unlabeled datapoints to a training dataset and training the machine learning model based on the training dataset. In this manner, the machine learning model is trained using a full set of training data.

According to another embodiment, an apparatus includes a memory and a hardware processor communicatively coupled to the memory. The hardware processor applies a machine learning model to a plurality of unlabeled datapoints to produce probability distributions for labels for the plurality of unlabeled datapoints, selects a first subset of unlabeled datapoints from the plurality of unlabeled datapoints based on a criterion, and selects a second subset of unlabeled datapoints from the first subset based on the probability distributions for labels for the unlabeled datapoints in the first subset. The second subset is smaller than the first subset. The hardware processor also communicates, to a user, the second subset of unlabeled datapoints, receives, from the user, labels for the second subset of unlabeled datapoints, and trains, using the received labels, the machine learning model. In this manner, the machine learning model's predictive performance for a slice of data is improved using active learning.

In some embodiments, the criterion specifies a first label and a second label. Each of the probability distributions for labels for the unlabeled datapoints in the second subset includes a highest probability and a second highest probability. The highest probability is for the first label and the second highest probability is for the second label. In this manner, the criterion defines a slice of data based on the initial predictions made for that data. Additionally, each unlabeled datapoint of the second subset may be selected based on a difference between the highest probability and the second highest probability of the probability distribution of the respective unlabeled datapoint being less than a threshold. In this manner, the slice of data is sampled to locate the data for which the machine learning model is least confident about its prediction.

In certain embodiments, each unlabeled datapoint of the second subset is selected based on an entropy of the probability distribution of the respective unlabeled datapoint exceeding a threshold. In this manner, the slice of data is sampled to locate the data for which the machine learning model is least confident about its prediction.

In particular embodiments, the hardware processor also, after training the machine learning model using the received labels, applies the machine learning model to the first subset of unlabeled datapoints to produce labels for the first subset of unlabeled datapoints. In this manner, the machine learning model generates more accurate predictions after training.

In some embodiments, the hardware processor also determines the criterion based on the probability distributions. In this manner, the machine learning model automatically determines the criterion to use to define a slice.

In certain embodiments, training the machine learning model includes adding the received labels and the second subset of unlabeled datapoints to a training dataset and training the machine learning model based on the training dataset. In this manner, the machine learning model is trained using a full set of training data.

According to another embodiment, a method includes applying a machine learning model to a plurality of unlabeled datapoints to produce a plurality of probability distributions for the plurality of unlabeled datapoints and selecting a subset of unlabeled datapoints from a slice of the plurality of unlabeled datapoints based on the probability distributions for the unlabeled datapoints in the slice, wherein the slice is determined based on a criterion. The method also includes receiving labels for the second subset of unlabeled datapoints and training, using the received labels, the machine learning model. In this manner, the machine learning model's predictive performance for a slice of data is improved using active learning.

In some embodiments, the criterion specifies a first label and a second label, wherein each of the probability distributions for the unlabeled datapoints in the subset comprises a highest probability and a second highest probability, and wherein the highest probability is for the first label and the second highest probability is for the second label. In this manner, the criterion defines a slice of data based on the initial predictions made for that data. Additionally, each unlabeled datapoint of the subset may be selected based on a difference between the highest probability and the second highest probability of the probability distribution of the respective unlabeled datapoint being less than a threshold. In this manner, the slice of data is sampled to locate the data for which the machine learning model is least confident about its prediction.

In certain embodiments, each unlabeled datapoint of the subset is selected based on an entropy of the probability distribution of the respective unlabeled datapoint exceeding a threshold. In this manner, the slice of data is sampled to locate the data for which the machine learning model is least confident about its prediction.

In some embodiments, the method also determines the criterion based on the plurality of probability distributions. In this manner, the machine learning model automatically determines the criterion to use to define a slice.

In certain embodiments, training the machine learning model includes adding the received labels and the subset of unlabeled datapoints to a training dataset and training the machine learning model based on the training dataset. In this manner, the machine learning model is trained using a full set of training data.

### BRIEF DESCRIPTION OF THE SEVERAL VIEWS OF THE DRAWINGS

FIG. 1 illustrates an example system.

FIG. 2 is a flowchart of an example method in the system of FIG. 1.

FIG. 3 illustrates an example training server in the system of FIG. 1.

FIG. 4 illustrates an example training server in the system of FIG. 1.

### DETAILED DESCRIPTION

This disclosure describes a training server that uses active learning to train a machine learning model on slices of data. The training server defines a slice of data by applying a criterion to the data. The training server may receive the criterion from a user or by applying the machine learning model to the data. The training server then samples the slice of data to determine a subset of data to be used for active learning. For example, the training server may select the data from the slice for which the machine learning model was least confident about its predictions. The training server then provides the subset of data to a user for labeling. After the data is labeled, the training server trains the machine learning model using the subset of data and the labels. In this manner, the machine learning model's predictive performance for a slice of data is improved using active learning.

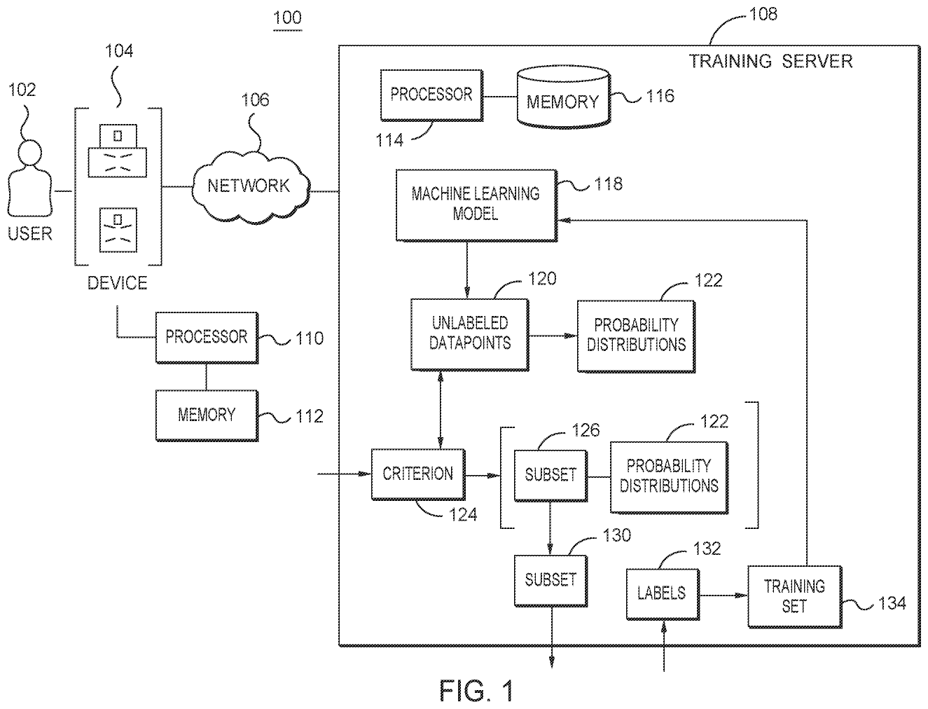

FIG. 1 illustrates an example system 100. As seen in FIG. 1, the system 100 includes one or more devices 104, a network 106, and a training server 108. Generally, the training server 108 allows a user 102 of the device 104 to indicate a slice of data on which a machine learning model should be trained. In particular embodiments, the training server 108 then trains the machine learning model to make more accurate predictions for datapoints in the slice of data.

The user 102 uses the device 104 to interact with other components of the system 100. For example, the user 102 may use the device 104 to indicate a slice of data to the training server 108. The training server 108 then trains a machine learning model to make more accurate predictions on that slice of data. As another example, the user 102 may use the device 104 to provide labels for data communicated by the training server 108. The communicated data may be from the slice of data indicated by the device 104. The labels provided by the user 102 indicate the correct prediction for the slice of data. The training server 108 uses the provided labels to train the machine learning model to make more accurate predictions, in particular embodiments. As seen in FIG. 1, the device 104 includes a processor 110 and a memory 112, which are configured to perform any of the actions or functions of the device 104 described herein. For example, a software application designed using software code may be stored in the memory 112 and executed by the processor 110 to perform the functions of the device 104.

The device 104 is any suitable device for communicating with components of the system 100 over the network 106. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user 102.

The processor 110 is any electronic circuitry, including, but not limited to microprocessors, application specific integrated circuits (ASIC), application specific instruction set processor (ASIP), and/or state machines, that communicatively couples to memory 112 and controls the operation of the device 104. The processor 110 may be 8-bit, 16-bit, 32-bit, 64-bit or of any other suitable architecture. The processor 110 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 110 may include other hardware that operates software to control and process information. The processor 110 executes software stored on the memory 112 to perform any of the functions described herein. The processor 110 controls the operation and administration of the device 104 by processing information (e.g., information received from the training server 108, network 106, and memory 112). The processor 110 may be a programmable logic device, a microcontroller, a microprocessor, any suitable processing device, or any suitable combination of the preceding. The processor 110 is not limited to a single processing device and may encompass multiple processing devices.

The memory 112 may store, either permanently or temporarily, data, operational software, or other information for the processor 110. The memory 112 may include any one or a combination of volatile or non-volatile local or remote devices suitable for storing information. For example, the memory 112 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 112, a disk, a CD, or a flash drive. In particular embodiments, the software may include an application executable by the processor 110 to perform one or more of the functions described herein.

The network 106 is any suitable network operable to facilitate communication between the components of the system 100. The network 106 may include any interconnecting system capable of transmitting audio, video, signals, data, messages, or any combination of the preceding. The network 106 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The training server 108 engages in active learning to train a machine learning model on slices of data indicated by the device 104. In particular embodiments, the training server 108 improves the machine learning model's performance or accuracy on the slices of data. As seen in FIG. 1, the training server 108 includes a processor 114 and a memory 116, which are configured to perform any of the functions or actions of the training server 108 described herein. For example, a software application designed using software code may be stored in the memory 116 and executed by the processor 114 to perform the functions of the training server 108.

The processor 114 is any electronic circuitry, including, but not limited to microprocessors, application specific integrated circuits (ASIC), application specific instruction set processor (ASIP), and/or state machines, that communicatively couples to memory 116 and controls the operation of the training server 108. The processor 114 may be 8-bit, 16-bit, 32-bit, 64-bit or of any other suitable architecture. The processor 114 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 114 may include other hardware that operates software to control and process information. The processor 114 executes software stored on the memory 116 to perform any of the functions described herein. The processor 114 controls the operation and administration of the training server 108 by processing information (e.g., information received from the devices 104, network 106, and memory 116). The processor 114 may be a programmable logic device, a microcontroller, a microprocessor, any suitable processing device, or any suitable combination of the preceding. The processor 114 is not limited to a single processing device and may encompass multiple processing devices.

The memory 116 may store, either permanently or temporarily, data, operational software, or other information for the processor 114. The memory 116 may include any one or a combination of volatile or non-volatile local or remote devices suitable for storing information. For example, the memory 116 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 116, a disk, a CD, or a flash drive. In particular embodiments, the software may include an application executable by the processor 114 to perform one or more of the functions described herein.

The training server 108 trains the machine learning model 118, which may be any model that makes predictions based on unlabeled data. In the example of FIG. 1, the machine learning model 118 analyzes unlabeled datapoints 120 to determine probability distributions 122. The machine learning model 118 determines a probability distribution 122 for each unlabeled datapoint 120 based on the information in the corresponding unlabeled datapoint 120. Each probability distribution 122 indicates the probabilities of various predicted outcomes for an unlabeled datapoint 120.

For example, if the machine learning model 118 analyzes handwritten numerals to predict the numbers that correspond to those handwritten numerals, then the unlabeled datapoints 120 are the handwritten numerals and the probability distributions 122 are the probabilities that any handwritten numeral is a particular digit from zero to nine. Thus, the machine learning model 118 determines, for each handwritten numeral, the probabilities that a handwritten numeral is a digit from zero through nine. For each handwritten numeral, the machine learning model 118 may output the digit with the highest probability in the probability distribution 122 for that handwritten numeral. In other words, the machine learning model 118 may predict that a handwritten numeral is the digit with the highest probability in the probability distribution 122 for that handwritten numeral.

As another example, the machine learning model 118 may predict health outcomes for patients based on their medical history or medical test data. In this example, the unlabeled datapoints 120 are the patient's medical histories and medical test data. The machine learning model 118 determines probability distributions 122 for each patient. The probability distributions 122 include probabilities for different diagnoses. The machine learning model 118 may output, for each patient, the diagnosis with the highest probability in the probability distribution 122 for that patient.

The training server 108 receives a criterion 124 from the device 104. The training server 108 uses the criterion 124 to generate a slice of data from the unlabeled datapoints 120. In the example of FIG. 1, the training server 108 selects a subset 126 of data from the unlabeled datapoints 120 using the criterion 124. The user 102 may have specified the criterion 124 to indicate the slice of data for which the machine learning model 118 should be trained for improved accuracy. Using the previous examples, the criterion 124 may indicate that the machine learning model 118 should be trained to better distinguish between the handwritten numerals one and seven. Using another previous example, the criterion 124 may indicate that the machine learning model 118 should be trained to predict a better diagnosis for patients over the age of 70. The training server 108 selects the unlabeled datapoints 120 that meet the criterion 124. For example, the training server 108 may select the unlabeled datapoints 120 for which the machine learning model 118 output a one or a seven. As another example, the training server 108 may select the unlabeled datapoints 120 that belong to patients that are over the age of 70. The training server 108 selects these datapoints to form the subset 126.

In certain embodiments, the training server 108 analyzes the probability distributions 122 to automatically determine the criterion 124. For example, the training server 108 may analyze probability distributions 122 that indicate higher levels of entropy or uncertainty. These probability distributions 122 may include probabilities that are close together, which makes a predictions based on the probability distributions 122 less certain. The training server 108 analyzes these probability distributions 122 to determine commonalities between or amongst these probability distributions 122. These commonalities may indicate the criterion 124 to be used to select the subset 126 of data from the unlabeled data points 120. For example, a commonality between or amongst the probability distributions 122 may be that the datapoints for these probability distributions 122 share common predicted labels (e.g., in a number classifier, the datapoints may be labeled as 1 or 7). As another example, a commonality between or amongst the probability distributions 122 may be that the datapoints for these probability distributions 122 share common characteristics (e.g., in a medical diagnosis system, the datapoints may be for patients within a certain age group). The training server 108 may form the criterion 124 using these common labels or common characteristics. In this manner, the criterion 124 may be applied to select the subset of datapoints 120 with these common labels or common characteristics.

The training server 108 then selects a subset 130 from the subset 126. The training server 108 selects the subset 130 based on the datapoints in the subset 126 for which the machine learning model 118 was least confident about its predictions. For example, to form the subset 130 the training server 108 may select the datapoints in the subset 126 with the smallest margin between the highest and second highest probabilities in their perspective probability distributions 122. As another example, the training server 108 may select the datapoints in the subset 126 for which the margin between the highest and second highest probabilities in their respective probability distributions 122 fall below a threshold. When a margin or difference between a highest probability and the second highest probability is small, it indicates that the machine learning model 118 was not confident about its prediction, or that the machine learning model 118 was not certain about the outcomes represented by the highest probability and the second highest probability. In this manner, the subset 130 includes the datapoints that belong in the slice of data defined by the criterion 124 and correspond with the least confident predictions. The training server 108 communicates the subset 130 to the device 104 for labeling.

In certain embodiments, the training server 108 forms the subset 130 by selecting the datapoints from the subset 126 that have a high level of entropy in their respective probability distributions 122. A probability distribution 122 with a high level of entropy may have probabilities that are close to each other, indicating a high level of uncertainty. A probability distribution 122 with a low level entropy may have probabilities that are far from each other, indicating a higher level of certainty. As a result, a probability distribution 122 with a higher level of entropy indicates that the machine learning model 118 was less confident about its prediction based on that probability distribution 122. The training server 108 selects the datapoints from the subset 126 with probability distributions 122 that have a high level of entropy to form the subset 130. For example, the training server 108 may select the datapoints of the subset 126 that have probability distributions 122 with an entropy that exceeds a threshold. As another example, the training server 108 may select the datapoints from the subset 126 with probability distributions 122 with a highest level of entropy amongst the probability distributions 122 for the subset 126.

The training server 108 receives labels 132 from the device 104 in response to communicating the subset 130 to the device 104. The labels 132 may have been provided by the user 102 after viewing the subset 130. Using the previous examples, the subset 130 may include handwritten numerals that were predicted to be ones or sevens. The user 102 may review these handwritten numerals and provide labels 132 that indicate whether these handwritten numerals are ones or sevens. As another example, the subset 130 may include the medical history and medical test data of certain patients over the age of 70. The user 102 may review the medical histories and medical test data and provide labels 132 that indicate the correct diagnoses for these patients.

The training server 108 adds the labels 132 to a training set 134. The training set 134 may include any data used to train the machine learning model 118. For example, the training set 134 may include the labels 132 provided by the user 102 and any other labeled data that can be used to train the machine learning model 118. The training server 108 then trains the machine learning model 118 using the training set 134. In particular embodiments, the training set 134 includes only the labels 132 provided by the user 102. In these embodiments, the training server 108 trains the machine learning model 118 using the labels 132. As a result, the machine learning model 118 is trained to make more accurate predictions on the slice of data defined by the criterion 124, in particular embodiments. Using the previous examples, the machine learning model 118 is trained to better distinguish between handwritten ones and sevens or to more accurately diagnose patients over the age of 70.

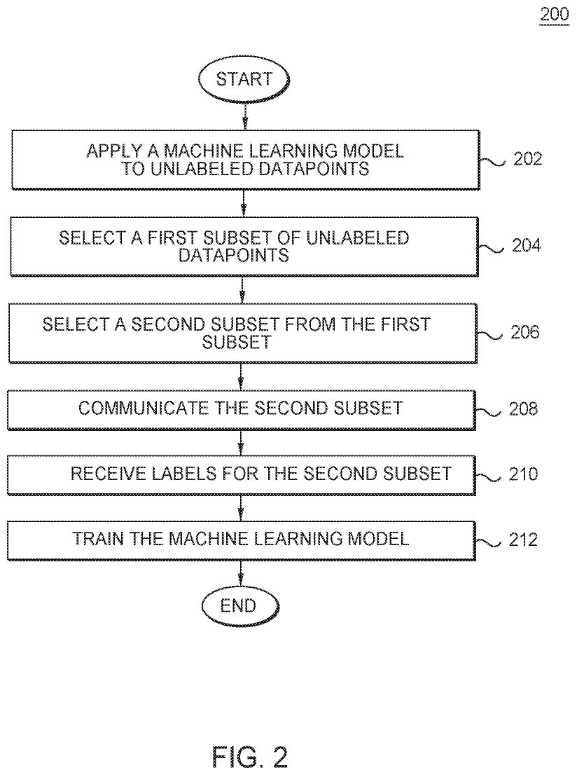

FIG. 2 is a flowchart of an example method 200 in the system 100 of FIG. 1. The training server 108 performs the method 200. In particular embodiments, by performing the method 200, the training server 108 engages in active learning to train the machine learning model 118 to make more accurate predictions for a slice of data.

In block 202, the training server 108 applies a machine learning model 118 to unlabeled datapoints 120. By applying the machine learning model 118 to the unlabeled datapoints 120, the machine learning model 118 produces probability distributions 122 for the unlabeled datapoints 120. Each unlabeled datapoint 120 has a corresponding probability distribution 122. Each probability distribution 122 includes probabilities for predictions based on the corresponding unlabeled datapoint 120.

In block 204, the training server 108 selects a first subset 126 of unlabeled datapoints 120. The training server 108 selects the first subset 126 based on a criterion 124. The criterion 124 may have been determined by a user 102 or by the training server 108. The criterion 124 defines a slice of the unlabeled datapoints 120 that form the first subset 126. For example, the criterion 124 may indicate characteristics of the unlabeled datapoints 120 (e.g., age group), and the first subset 126 may include the unlabeled datapoints 120 that have the characteristics indicated by the criterion 124 (e.g., patients in the age group). As another example, the criterion 124 may indicate certain labels or predicted outcomes (e.g., predicted ones or sevens), and the first subset 126 may include the unlabeled datapoints 120 for which the machine learning model 118 predicted those labels or outcomes (e.g., the handwritten numerals predicted to be ones or sevens).

In block 206, the training server 108 selects a second subset 130 from the first subset 126. The second subset 130 includes the datapoints from the first subset 126 for which the machine learning model 118 made the least confident predictions. For example, the second subset 30 includes datapoints from the first subset 126 whose probability distributions 122 have a high level of entropy. As another example, the second subset 130 may include datapoints from the first subset 126 whose probability distributions 122 have a small margin or difference between a highest probability and a second highest probability.

In block 208, the training server 108 communicates the second subset 130 to a user 102 or a device 104. The user 102 may use the device 104 to review the second subset 130 and to provide labels 132 for the second subset 130. The training server 108 receives the labels 132 for the second subset 130 in block 210. The training server 108 then trains the machine learning model 118 using the provided labels 132 in block 212. In some embodiments, the training server 108 adds the provided labels 132 to a training set 134 so that the training set 134 includes the provide labels 132 and any other labeled data that can be used to train the machine learning model 118. The training server 108 then trains the machine learning model 118 using the training set 134 in block 212. In this manner, the machine learning model 118 is trained using labeled data that is generated for a specific slice of data so that the machine learning model's 118 performance or accuracy improves for that slice of data, in particular embodiments. Specifically, the machine learning model 118 is trained to make more accurate predictions for the unlabeled datapoints 120 in the first subset 126 or the unlabeled datapoints 120 in the slice of data. As a result, the machine learning model 118 can be trained using active learning while having the training target specific weaknesses of the machine learning model 118.

The training server 108 may not communicate the remaining portion of the first subset 126 that was not selected for the second subset 130 for labelling. Because the remaining portion of the first subset 126 included predictions for which the machine learning model 118 was more confident, it may not improve the machine learning model's 118 performance or accuracy significantly to label the remaining portion of the first subset 126 and then train the machine learning model 118 using that labeled data. Stated differently, the labels for this data may not instruct the machine learning model 118 of any errors that the machine learning model 118 made.

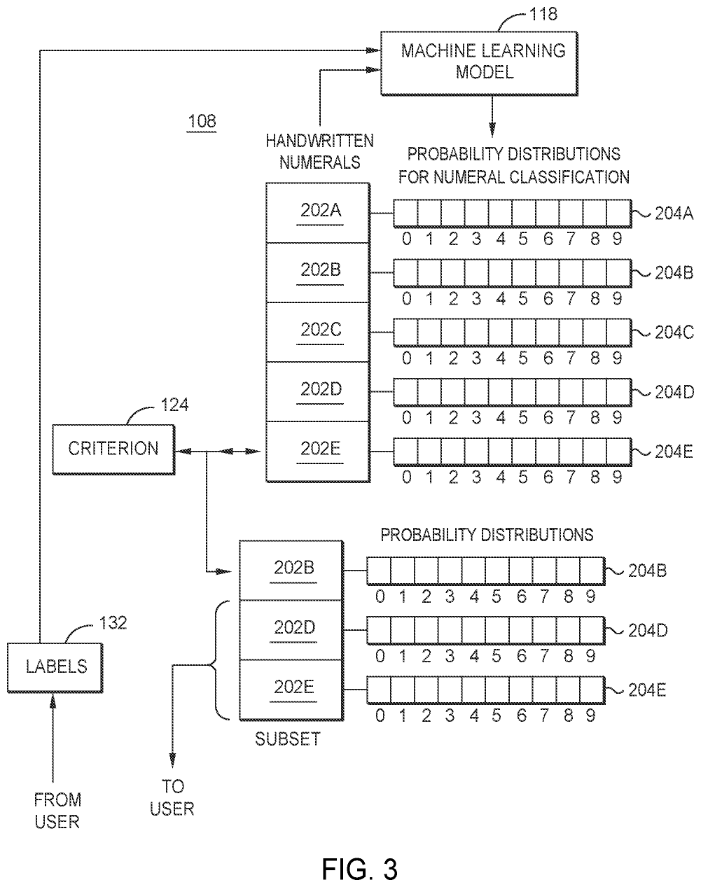

FIG. 3 illustrates an example training server 108 in the system 100 of FIG. 1. Generally, the training server 108 in the example of FIG. 3 applies a machine learning model 118 to identify or classify handwritten numerals. The training server 108 uses active learning to train the machine learning model 118 to better identify or classify specific numerals.

The training server 108 makes predictions for one or more handwritten numerals 202. The handwritten numerals 202, which are an example of the unlabeled datapoints 120 in the example of FIG. 1. As seen in the example of FIG. 3, the training server 108 makes predictions for five handwritten numerals 202A, 202B, 202B, 202D, and 202E. The training server 108 applies the machine learning model 118 on the handwritten numerals 202 to identify each handwritten numeral 202.

The machine learning model 118 analyzes each handwritten numeral 202 and determines a probability distribution 204 for each handwritten numeral 202. Each probability distribution 204 includes probabilities that a particular handwritten numeral 202 is a zero through nine. The machine learning model 118 analyzes each handwritten numeral 202 to determine the probabilities in each probability distribution 204. As seen in FIG. 3, the training server 108 determines probability distributions 204A, 204B, 204C, 204D, and 204E for the handwritten numerals 202A, 202B, 202C, 202D, and 202E. Each probability distribution 204 includes a probability that the corresponding handwritten numeral 202 is a particular digit from zero through nine.

The machine learning model 118 identifies a handwritten numeral 202 based on the probabilities in the probability distribution 204 for that handwritten numeral 202. For example, the machine learning model 118 may predict that a handwritten numeral 202 is the digit corresponding to the highest probability in the probability distribution 204 for that handwritten numeral 202. If the probability distribution 204A indicates that the digit three has the highest probability out of the digits in the probability distribution 204A, then the machine learning model 118 may predict that the handwritten numeral 220A is a three.

The training server 108 applies a criterion 124 to generate a slice of the handwritten numerals 202. The criterion 124 may be provided by a user 102 or automatically determined by the machine learning model 118. In the example of FIG. 3, the criterion 124 indicates labels or predicted outcomes for which the machine learning model 118 should receive further training. In response to this criterion 124, the training server 108 selects a subset 126 of the handwritten numerals 202 for which the machine learning model 118 prediction is equal to one or more of the labels in the criterion 124. For example, the criterion 124 may indicate the labels one and seven, which indicates that the machine learning model 118 should improve at identifying or distinguishing between ones and sevens. The training server 108 selects the handwritten numerals 202 for which the machine learning model's 118 prediction is a one or a seven. As seen in FIG. 3, the training server 108 selects the handwritten numerals 202B, 202D, and 202E, because the machine learning model's 118 prediction for these handwritten numerals 202 matched the labels provided in the criterion 124.

The training server 108 then analyzes the probability distributions 204 for the subset of handwritten numerals 202 to select a second subset of handwritten numerals 202. As discussed previously, the training server 108 may select the handwritten numerals 202 whose probability distributions 204 include a low margin or difference between a highest probability and a second highest probability. For example, the training server 108 may select the numerals 202 whose probability distributions 204 have a difference between a highest probability and a second highest probability that is below a threshold. In some embodiments, the training server 108 selects the handwritten numerals 202 whose probability distributions 204 have a high level of entropy. For example, the training server 108 may select the handwritten numerals 202 whose probability distributions 204 have probabilities that are close to each other. In the example of FIG. 3, the training server 108 selects the handwritten numerals 202D and 202E. The training server 108 may select the handwritten numerals 202D and 202E from the subset, because the probability distributions 204D and 204E have probabilities for the digits one and seven that are close in value. In other words, a difference between the probabilities for the digits one and seven in the probability distributions 204D and 204E is small.

The training server 108 communicates the handwritten numerals 202 selected from the subset to a user 102. The user 102 then provides labels 132 for the selected handwritten numerals 202. In the example of FIG. 3, the training server 108 communicates the handwritten numerals 202D and 202E to the user 102. The user 102 then provides labels 132 that identify these handwritten numerals 202. The training server 108 then trains the machine learning model 118 using the provided labels 132. In this manner, the training server 108 uses active learning to train the machine learning model 118 to better identify a subset of the possible digits.

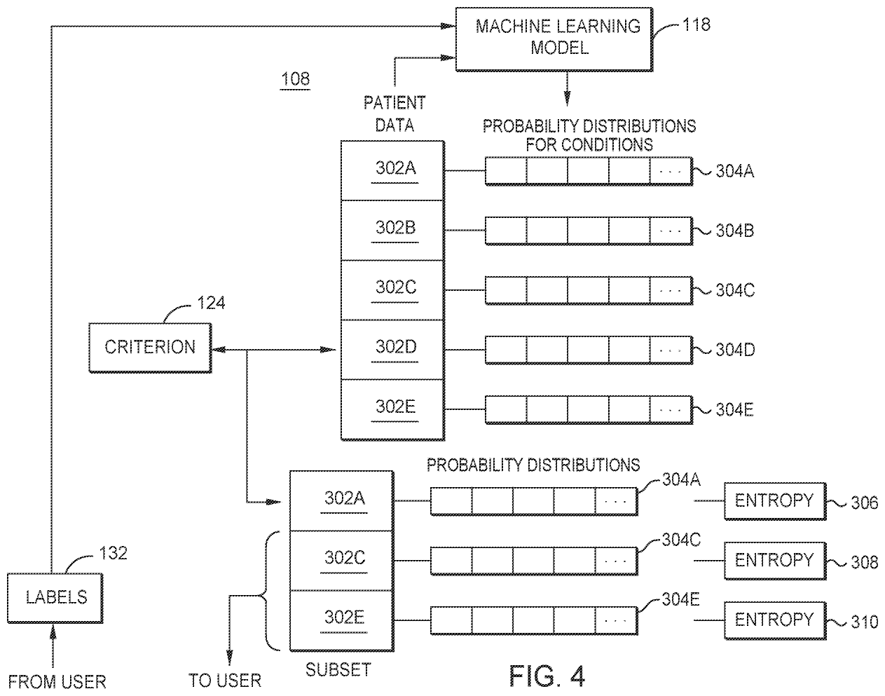

FIG. 4 illustrates an example training server 108 in the system 100 of FIG. 1. Generally, the training server 108 in FIG. 4 applies a machine learning model 118 to diagnose patients. The training server 108 uses active learning to train the machine learning model 118 to more accurately diagnose specific patients (e.g., patients of a particular age).

The training server 108 applies the machine learning model 118 to patient data 302. The patient data 302 may include medical histories and medical test data for particular patients. In the example of FIG. 4, the training data 108 includes patient data 302A, 302B, 302C, 302D, and 302E. Each patient data 302 includes medical history and medical test data for a particular patient. The patient data 302 may also include characteristics of the patient (e.g., the patient's age).

The machine learning model 118 analyzes the patient data 302 to determine probability distributions 304 for each patient. Each probability distribution 304 includes probabilities that a patient has certain medical conditions. As seen in FIG. 4, the machine learning model 118 determines probability distributions 304A, 304B, 304C, 304D, and 304E for the patient data 302A, 302B, 302C, 302D, and 302E. The machine learning model 118 may predict that a patient has a condition with the highest probability in the probability distribution 304 for that patient.

The training server 108 uses a criterion 124 to generate a slice of the patient data 302. The criterion 124 may specify a characteristic of the patient data 302 on which the slice should be generated. For example, the criterion 124 may specify patients over the age of 70. The training server 108 applies the criterion 124 to select a subset of the patient data 302. For example, the training server 108 may apply the criterion 124 to select the patient data 302 for patients over the age of 70. In the example of FIG. 4, the training server 108 selects the patient data 302A, 302C, and 302E based on the criterion 124.

The training server 108 then analyzes the probability distributions 304 corresponding to the selected patient data 302 to determine a second subset of patient data 302 to communicate for labeling. The training server 108 may analyze the probabilities in the probability distributions 304 to determine which patient data 302 to select for labeling. In the example of FIG. 4, the training server 108 selects the patient data 302 for labeling based on an entropy level of the probability distributions 304 for the patient data 302. As seen in FIG. 4, the probability distribution 304A has an entropy 306, the probability distribution 304C has an entropy 308, and the probability distribution 304E has an entropy 310. Each of the entropies 306, 308 and 310 indicate how close the probabilities in the corresponding probability distributions 304 are to each other. The training server 108 may select patient data 302 if the entropy level of the corresponding probability distribution 304 is above a threshold. In the example of FIG. 4, the training server 108 selects the patient data 302C and 302E for labelling based on the entropy levels 308 and 310. For example, the entropies 308 and 310 may be above a threshold but the entropy 306 may not exceed the threshold. As a result, the training server 108 selects the patient data 302C and 302E for labeling.

The training server 108 communicates the patient data 302C and 302E to a user 102 for labeling. The user 102 reviews the patient data 302C and 302E and provides labels 132 that indicate a correct diagnosis for the patient data 302C and 302E. The training server 108 then trains the machine learning model 118 with the provided labels 132 so that the machine learning model 118 more accurately diagnoses patients who are over the age of 70 in the future.

In summary, a training server 108 uses active learning to train a machine learning model 118 on slices of data. The training server 108 defines a slice of data by applying a criterion 124 to the data. The training server 108 may receive the criterion 124 from a user 102 or by applying the machine learning model 118 to the data. The training server 108 then samples the slice of data to determine a subset of data to be used for active learning. For example, the training server 108 may select the data from the slice for which the machine learning model 118 was least confident about its predictions. The training server 108 then provides the subset of data to a user 102 for labeling. After the data is labeled, the training server 108 trains the machine learning model 118 using the subset of data and the labels 132. In this manner, the machine learning model's 118 predictive performance for a slice of data is improved using active learning.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the training server 108) or related data available in the cloud. For example, the training server 108 could execute on a computing system in the cloud and train the machine learning model 118. In such a case, the training server 108 could receive unlabeled datapoints 120 over the cloud and train the ma chine learning model 118. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
applying a machine learning model to a plurality of unlabeled datapoints to produce probability distributions for labels for the plurality of unlabeled datapoints;
selecting a first subset of unlabeled datapoints from the plurality of unlabeled datapoints that satisfy a criterion;
selecting a second subset of unlabeled datapoints from the first subset based on the probability distributions for labels for the unlabeled datapoints in the first subset, the second subset is smaller than the first subset;
communicating, to a user, the second subset of unlabeled datapoints;
receiving, from the user, labels for the second subset of unlabeled datapoints; and
training, using the received labels, the machine learning model.

2. The method of claim 1, wherein the criterion specifies a first label and a second label, wherein each of the probability distributions for labels for the unlabeled datapoints in the second subset comprises a highest probability and a second highest probability, and wherein the highest probability is for the first label and the second highest probability is for the second label.

3. The method of claim 2, wherein each unlabeled datapoint of the second subset is selected based on a difference between the highest probability and the second highest probability of a probability distribution of the respective unlabeled datapoint being less than a threshold.

4. The method of claim 1, wherein each unlabeled datapoint of the second subset is selected based on an entropy of a probability distribution of the respective unlabeled datapoint exceeding a threshold.

5. The method of claim 1, further comprising, after training the machine learning model using the received labels, applying the machine learning model to the first subset of unlabeled datapoints to produce labels for the first subset of unlabeled datapoints.

6. The method of claim 1, further comprising determining the criterion based on the probability distributions.

7. The method of claim 1, wherein training the machine learning model comprises:
adding the received labels and the second subset of unlabeled datapoints to a training dataset; and
training the machine learning model based on the training dataset.

8. An apparatus comprising:
a memory; and
a hardware processor communicatively coupled to the memory, the hardware processor configured to:
apply a machine learning model to a plurality of unlabeled datapoints to produce probability distributions for labels for the plurality of unlabeled datapoints;
select a first subset of unlabeled datapoints from the plurality of unlabeled datapoints that satisfy a criterion;
select a second subset of unlabeled datapoints from the first subset based on the probability distributions for labels for the unlabeled datapoints in the first subset, the second subset is smaller than the first subset;
communicate, to a user, the second subset of unlabeled datapoints;
receive, from the user, labels for the second subset of unlabeled datapoints; and
train, using the received labels, the machine learning model.

9. The apparatus of claim 8, wherein the criterion specifies a first label and a second label, wherein each of the probability distributions for labels for the unlabeled datapoints in the second subset comprises a highest probability and a second highest probability, and wherein the highest probability is for the first label and the second highest probability is for the second label.

10. The apparatus of claim 9, wherein each unlabeled datapoint of the second subset is selected based on a difference between the highest probability and the second highest probability of a probability distribution of the respective unlabeled datapoint being less than a threshold.

11. The apparatus of claim 8, wherein each unlabeled datapoint of the second subset is selected based on an entropy of a probability distribution of the respective unlabeled datapoint exceeding a threshold.

12. The apparatus of claim 8, the hardware processor further configured to, after training the machine learning model using the received labels, apply the machine learning model to the first subset of unlabeled datapoints to produce labels for the first subset of unlabeled datapoints.

13. The apparatus of claim 8, the hardware processor further configured to determine the criterion based on the probability distributions.

14. The apparatus of claim 8, wherein training the machine learning model comprises:
adding the received labels and the second subset of unlabeled datapoints to a training dataset; and
training the machine learning model based on the training dataset.

15. A method comprising:
applying a machine learning model to a plurality of unlabeled datapoints to produce a plurality of probability distributions for the plurality of unlabeled datapoints;
selecting a subset of unlabeled datapoints from a slice of the plurality of unlabeled datapoints based on the probability distributions for the unlabeled datapoints in the slice, wherein the slice is determined based on a criterion;
receiving labels for the subset of unlabeled datapoints; and
training, using the received labels, the machine learning model.

16. The method of claim 15, wherein the criterion specifies a first label and a second label, wherein each of the probability distributions for the unlabeled datapoints in the subset comprises a highest probability and a second highest probability, and wherein the highest probability is for the first label and the second highest probability is for the second label.

17. The method of claim 16, wherein each unlabeled datapoint of the subset is selected based on a difference between the highest probability and the second highest probability of a probability distribution of the respective unlabeled datapoint being less than a threshold.

18. The method of claim 15, wherein each unlabeled datapoint of the subset is selected based on an entropy of a probability distribution of the respective unlabeled datapoint exceeding a threshold.

19. The method of claim 15, further comprising determining the criterion based on the plurality of probability distributions.

20. The method of claim 15, wherein training the machine learning model comprises:
adding the received labels and the subset of unlabeled datapoints to a training dataset; and
training the machine learning model based on the training dataset.
